(19) United States
(12) Patent Application Publication
(10) Pub. No.: US 2011/0109610 A1
(43) Pub. Date: May 12, 2011

(54) Display device and electronic apparatus

(75) Inventors: Tetsuro Yamamoto, Kanagawa (JP); Katsuhide Uchino, Kanagawa (JP); Naobumi Toyomura, Kanagawa (JP)

(73) Assignee: Sony Corporation, Tokyo (JP)

(21) Appl. No.: 12/926,181

(22) Filed: Oct. 29, 2010

(30) Foreign Application Priority Data
Nov. 9, 2009 (JP) 2009-255646

(51) Int. Cl. G09G 5/00; G09G 3/30

(52) U.S. Cl. 345/211; 345/76

(57) ABSTRACT

A display device includes: pixel circuits; a signal electric potential generating unit generating a first signal electric potential used for increasing the number of gray scales of luminance of light emission of the pixel circuits and a second signal electric potential equal to or higher than the first signal electric potential, based on a video signal; and a control signal generating unit generating a control signal used for supplying the first and second signal electric potentials to the pixel circuits. Each of the pixel circuits includes a holding capacitor used for maintaining a signal voltage corresponding to the second signal electric potential, a writing transistor writing the second signal electric potential to the holding capacitor based on the control signal after writing the first signal electric potential, a driving transistor outputting a signal current based on the signal voltage corresponding to mobility of the driving transistor at the first signal electric potential written by the writing transistor, and a light emitting device emitting light in accordance with the signal current.

### BACKGROUND OF THE INVENTION

1. Field of the Invention

The present invention relates to an electronic apparatus, and more particularly, to a display device using a light emitting device in a pixel and an electronic apparatus including the display device.

2. Description of the Related Art

Recently, as light emitting devices, planar light-emitting-type display devices using an organic EL (Electroluminescence) device are actively developed. For example, as a display device using the organic EL device, a display device that controls the magnitude of a current supplied to an organic thin film by using a driving transistor that is used for allowing the organic EL device, which is included in a pixel circuit, to emit light is proposed (for example, see JP-A-2007-310311 (FIG. 1)).

### SUMMARY OF THE INVENTION

In the above-described related art, a signal current corresponding to a signal electric potential can be supplied to the organic EL device by applying the signal electric potential, which is generated based on a video signal of a video to be displayed, to the gate terminal of the driving transistor. Accordingly, the display device can allow the organic EL device to emit light in accordance with the magnitude of the signal current at the signal voltage. In such display devices, as a technique for increasing the number of gray scales of the luminance of the organic EL device, a method in which the number of steps of the signal electric potential generated based on the video signal is increased may be considered. However, when the number of steps of the signal electric potential is increased, the scale of a signal driver that generates the signal electric potential is necessarily increased. Therefore, there is a problem that the manufacturing cost is increased.

Thus, it is desirable to increase the number of gray scales of the luminescence of a display device without increasing the number of steps of a signal electric potential that is generated based on a video signal.

According to an embodiment of the present invention, there are provided a display device and an electronic apparatus that include: a plurality of pixel circuits; a signal electric potential generating unit that generates a first signal electric potential, which is used for increasing the number of gray scales of luminance of light emission of the pixel circuits, and a second signal electric potential, which is equal to or higher than the first signal electric potential, based on a video signal; and a control signal generating unit that generates a control signal used for supplying the first and second signal electric potentials to the pixel circuits. Each of the plurality of the pixel circuits includes a holding capacitor used for maintaining a signal voltage corresponding to the second signal electric potential, a writing transistor that writes the second signal electric potential to one end of the holding capacitor based on the control signal after writing the first signal electric potential, a driving transistor that outputs a signal current based on the signal voltage corresponding to mobility of the driving transistor at the first signal electric potential written by the writing transistor, and a light emitting device that emits light in accordance with the signal current output from the driving transistor. Accordingly, an effect of increasing the number of steps of the signal voltage that is maintained in the holding capacitor is acquired by supplying a current corresponding to the mobility of the driving transistor at the first signal electric potential, out of the first and second signal electric potentials generated based on the video signal by the signal electric potential generating unit, to the other end of the holding capacitor.

In addition, in the above-described embodiment, the signal electric potential generating unit may decrease a step width of the second signal electric potential as the second signal electric potential decreases. In such a case, an effect of decreasing the gray scale interval of the luminance as the luminance level of the pixel circuit decreases is acquired. In the case, it may be configured that the signal electric potential generating unit generates an electric potential used for suppressing supply of the current corresponding to the mobility from the driving transistor to the other end of the holding capacitor in a low signal range in which the second signal electric potential is low as the second signal electric potential, and the driving transistor outputs the signal current based on the signal voltage corresponding to the mobility at the second signal electric potential. In such a case, when the second signal electric potential is within the low signal range, an effect of maintaining the signal voltage in the holding capacitor is acquired by supplying only the current corresponding to the mobility of the driving transistor at the second signal electric potential to the other end of the holding capacitor. In the case, the signal electric potential generating unit may generate an electric potential used for suppressing supply of the current corresponding to the mobility from the driving transistor to the other end of the holding capacitor in the low signal range that is about 1/10 of the entire range of the second signal electric potential as the first signal electric potential. In such a case, when the second signal electric potential is within the low signal range that is about 1/10 of the entire range of the second signal electric potential, an effect of generating an electric potential for suppressing an increase in the electric potential of the other end of the holding capacitor through mobility correction as the first signal electric potential by using the signal electric potential generating unit is acquired.

In addition, in the case where the step width of the second signal electric potential is decreased as the second signal electric potential decreases, the signal electric potential generating unit may generate the first and second signal electric potentials that are the same electric potential in the low signal range in which the second signal electric potential is low. In such a case, when the second signal electric potential is within the low signal range, an effect of generating the first signal electric potential that is the same as the second signal electric potential using the signal electric potential generating unit is acquired.

In addition, in the above-described embodiment, it may be configured that a selection circuit that selects an electric potential for which a voltage maintained in the holding capacitor is equal to or lower than a voltage corresponding to a threshold voltage of the driving transistor and supplies the selected electric potential to the pixel circuits until the second signal electric potential is generated after the first signal electric potential is generated by the signal electric potential generating unit is further included, and the writing transistor supplies the electric potential selected by the selection circuit to the one end of the holding capacitor. In such a case, an effect of supplying the electric potential selected by the selection circuit to the one end of the holding capacitor until the second signal electric potential is generated after the first signal electric potential is generated by the signal electric potential generating unit is acquired.

According to the embodiment of the present invention, a superior advantage of increasing the number of gray scales of the luminance of a display device without increasing the number of steps of the signal electric potential generated based on a video signal can be acquired.

### BRIEF DESCRIPTION OF THE DRAWINGS

FIG. 1 is a conceptual diagram representing a configuration example of a display device according to a first embodiment of the present invention.

FIG. 2 is a circuit diagram schematically representing one configuration example of a pixel circuit according to the first embodiment of the present invention.

FIG. 3 is a timing chart of an operation example of the pixel circuit according to the first embodiment of the present invention.

FIGS. 4A to 4C are schematic circuit diagrams representing the operation states of the pixel circuit corresponding to the periods TP9, TP1, and TP2.

FIGS. 5A to 5C are schematic circuit diagrams representing the operation states of the pixel circuit corresponding to the periods TP3 to TP5.

FIGS. 6A to 6C are schematic circuit diagrams representing the operation states of the pixel circuit corresponding to the periods TP6 to TP8.

FIG. 7 is a schematic circuit diagram representing the operation state of the pixel circuit corresponding to the period TP9.

FIG. 8 is a diagram representing an example of the correspondence relationship between a second signal electric potential (Vsig2) supplied to a pixel circuit according to the first embodiment of the present invention and the luminance of the pixel circuit.

FIGS. 9A and 9B are diagrams relating to an example of setting the first and second signal electric potentials (Vsig1 and Vsig2) corresponding to the luminance gray scales of 4 k−4 to 4 k+4 shown in FIG. 8.

FIGS. 10A and 10B are diagrams relating to a modified example of setting the first and second signal electric potentials (Vsig1 and Vsig2) corresponding to the luminance gray scales of 4 k−4 to 4 k+4 shown in FIG. 8.

FIG. 11 is an example of a television set according to a second embodiment of the present invention.

FIG. 12 is an example of a digital still camera according to the second embodiment of the present invention.

FIG. 13 is an example of a notebook personal computer according to the second embodiment of the present invention.

FIG. 14 is an example of a mobile terminal device according to the second embodiment of the present invention.

FIG. 15 is an example of a video camera according to the second embodiment of the present invention.

### DESCRIPTION OF THE PREFERRED EMBODIMENTS

Hereinafter, embodiments of the present invention (hereinafter, referred to as embodiments) will be described. The description will be presented in the following order.

1. First Embodiment (Display Control: Example In Which Step Widths of First and Second Signal Electric Potentials Are Decreased For Low Luminance Range)

2. Second Embodiment (Display Control: Example of Electronic Apparatus Including Display Device 100)

### 1. First Embodiment

### [Configuration Example of Display Device 100]

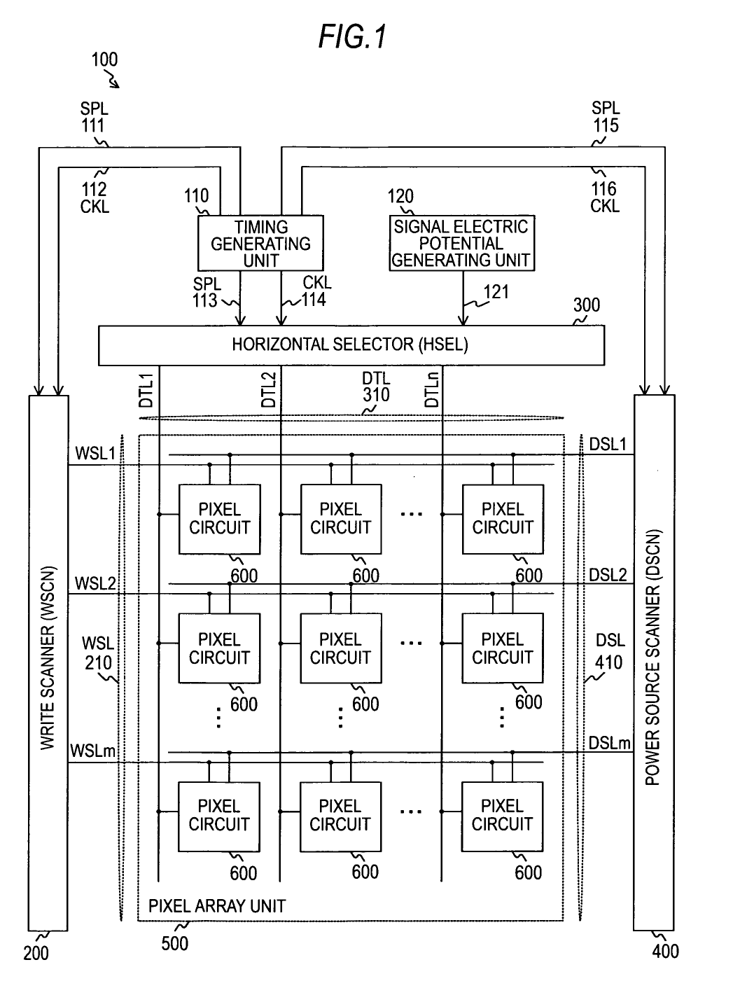

FIG. 1 is a conceptual diagram representing a configuration example of a display device 100 according to a first embodiment of the present invention. The display device 100 includes a timing generating unit 110, a signal electric potential generating unit 120, a write scanner (WSCN: Write SCaNner) 200, and a horizontal selector (HSEL: Horizontal SELector) 300. In addition, this display device 100 includes a power source scanner (DSCN: Drive SCaNner) 400 and a pixel array unit 500. The pixel array unit 500 includes n×m (m and n are integers equal to or greater than two) pixel circuits 600 arranged in a two-dimensional matrix pattern. Here, for convenience of the description, nine pixel circuits 600 arranged in the first, second and n-th columns of the first, second, and m-th rows are shown.

In addition, in the display device 100, scanning lines (WSL: Write Scan Line) 210 that are connected between the pixel circuits 600 and the write scanner (WSCN) 200 are disposed. In addition, in the display device 100, power source lines (DSL: Drive Scan Line) 410 that are connected between the pixel circuits 600 and the power source scanner (DSCN) 400 are disposed. Here, for convenience of the description, the scanning lines (WSL1, WSL2, and WSLm) 210 and the power source lines (DSL1, DSL2, and DSLm) 410 of the first, second, and m-th rows are shown.

In addition, in the display device 100, data lines (DTL: DaTa Line) 310 that are connected between the pixel circuits 600 and the horizontal selector (HSEL) 300 are disposed. Here, for convenience of the description, the data lines (DTL1, DTL2, and DTLn) 310 of the first, second, and n-th columns are shown.

The timing generating unit 110 generates a clock pulse that is used for setting up the synchronization of the write scanner (WSCN) 200, the horizontal selector (HSEL) 300, and the power source scanner (DSCN) 400. In other words, this timing generating unit 110 generates a start pulse that is used for the start of light emission of a pixel circuit 600. In addition, the timing generating unit 110 supplies a start pulse corresponding to the write scanner (WSCN) 200 to the write scanner (WSCN) 200 through a start pulse line (SPL: Start Pulse Line) 111. In addition, the timing generating unit 110 supplies a clock pulse corresponding to the write scanner (WSCN) 200 to the write scanner (WSCN) 200 through a clock pulse line (CKL: ClocK pulse Line) 112.

In addition, this timing generating unit 110 supplies the start pulse and the clock pulse, which have been generated, to the horizontal selector (HSEL) 300 through a start pulse line (SPL) 113 and a clock pulse line (CKL) 114. Furthermore, the timing generating unit 110 supplies the start pulse and the clock pulse, which have been generated, to the power source scanner (DSCN) 400 through a start pulse line (SPL) 115 and a clock pulse line (CKL) 116.

The signal electric potential generating unit 120 is a signal driver that generates a signal electric potential corresponding to a video signal of a video to be displayed through a predetermined number of steps. This signal electric potential generating unit 120, for example, generates a signal electric potential through the number of steps of 8 bits (256) based on the video signal. The signal electric potential generating unit 120 generates first and second signal electric potentials based on the video signal so as to increase the number of gray scales of the light emission luminance of the pixel circuit 600 to be more than the number of steps of the signal electric potential.

The signal electric potential generating unit 120, for example, maintains a correspondence table that represents the magnitudes of the first and second signal electric potentials corresponding to the magnitude of a video signal in advance and generates the first and second signal electric potentials based on the correspondence table. This signal electric potential generating unit 120 supplies the generated first and second signal electric potentials to the horizontal selector (HSEL) 300 through a signal electric potential line 121. Here, the signal electric potential generating unit 120 is an example of a signal electric potential generating unit according to an embodiment of the present invention.

The write scanner (WSCN) 200 performs line-sequential scanning in which the pixel circuits 600 are sequentially scanned in units of one row. This write scanner (WSCN) 200 controls a timing at which a data signal transmitted through the data line (DTL) 310 is supplied to the pixel circuit 600 unit in units of one row in synchronization with the clock pulse transmitted through the clock pulse line (CKL) 112.

This write scanner (WSCN) 200 generates a control signal that is used for supplying a signal transmitted through the data line (DTL) 310 to the pixel circuit 600 as a scanning signal based on the start pulse that is supplied through the start pulse line (SPL) 111. In addition, the write scanner (WSCN) 200 supplies the generated scanning signal to the scanning line (WSL) 210. Here, the write scanner (WSCN) 200 is an example of a control signal generating unit according to an embodiment of the present invention.

The horizontal selector (HSEL) 300 supplies data signals, which are used for setting the intensity of the light emission luminance of each pixel circuit 600, to the pixel circuits 600 of each column in accordance with line sequential scanning performed by the write scanner (WSCN) 200. In addition, the horizontal selector (HSEL) 300 generates a data signal based on the start pulse that is supplied through the start pulse line (SPL) 113.

This horizontal selector (HSEL) 300 generates a reference electric potential that is used for correcting (threshold value correction) variations in the threshold voltages of the driving transistors configuring the pixel circuits 600. Then, the horizontal selector (HSEL) 300 selects any one of the first and second signal electric potentials, which are transmitted from the signal electric potential generating unit 120, and the reference electric potential and supplies the selected electric potential to the data line (DTL) 310 as a data signal. Here, the horizontal selector (HSEL) 300 is an example of a selection circuit according to an embodiment of the present invention.

The power source scanner (DSCN) 400 generates a power source signal, which is used for driving the pixel circuit 600, in units of one row in accordance with the line sequential scanning performed by the write scanner (WSCN) 200. The power source scanner (DSCN) 400 generates a power source signal based on a start pulse that is supplied through the start pulse line (SPL) 113. In addition, the power source scanner (DSCN) 400 supplies the generated power source signal to the power source line (DSL) 410.

The pixel circuit 600 emits light based on the data signal that is supplied through the data line (DTL) 310 based on the scanning signal transmitted through the scanning line (WSL) 210. This pixel circuit 600 is an example of a pixel circuit according to an embodiment of the present invention. Here, a configuration example of the pixel circuit 600 will be described below with reference to a drawing.

### [Configuration Example of Pixel Circuit]

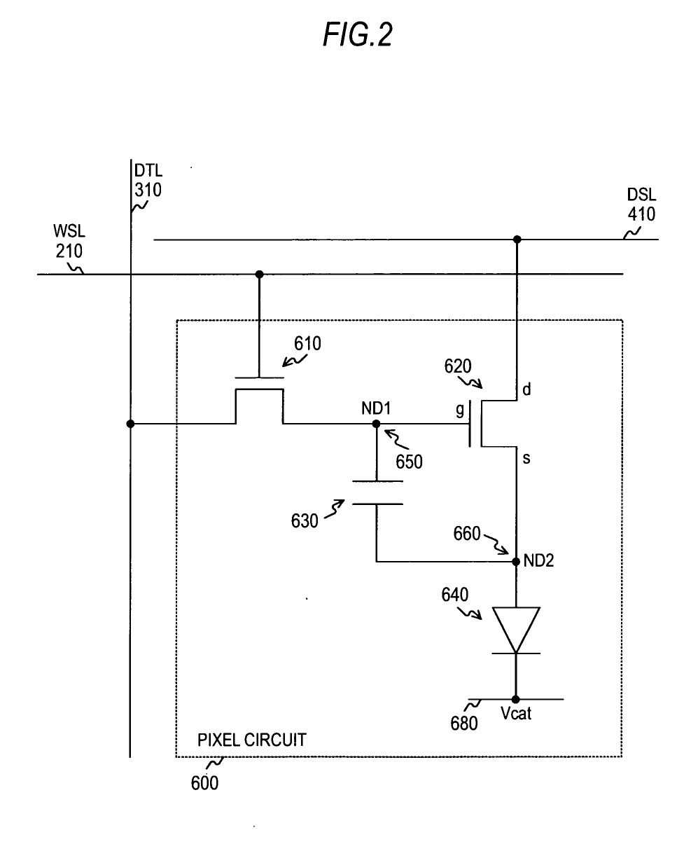

FIG. 2 is a circuit diagram schematically representing one configuration example of a pixel circuit 600 according to the first embodiment of the present invention. The pixel circuit 600 includes a writing transistor 610, a driving transistor 620, a holding capacitor 630, and a light emitting device 640. Here, a case where the writing transistor 610 and the driving transistor 620 are n-channel transistors will be described.

In the pixel circuit 600, a scanning line (WSL) 210 and a data line (DTL) 310 are connected to the gate terminal and the drain terminal of the writing transistor 610. In addition, to the source terminal of the writing transistor 610, the gate terminal (g) of the driving transistor 620 and one electrode (one end thereof) of the holding capacitor 630 are connected. Here, this connection portion will be referred to as a first node (ND1) 650. In addition, a power source line (DSL) 410 is connected to the drain terminal (d) of the driving transistor 620, and the other electrode (the other end thereof) of the holding capacitor 630 and the anode electrode of the light emitting device 640 are connected to the source terminal(s) of the driving transistor 620. Here, this connection potion will be referred to as a second node (ND2) 660.

The writing transistor 610 is a transistor that supplies the data signal transmitted through the data line (DTL) 310 to the first node (ND1) 650 in accordance with a scanning signal transmitted through the scanning line (WSL) 210. This writing transistor 610 supplies the reference electric potential included in the data signal to one end of the holding capacitor 630 so as to eliminate variations in the threshold voltages of the driving transistors 620 of the pixel circuits 600. The reference electric potential mentioned here is a fixed electric potential that becomes a reference for maintaining a voltage corresponding to the threshold voltage of the driving transistor 620 in the holding capacitor 630.

In addition, the writing transistor 610, after a voltage corresponding to the threshold voltage of the driving transistor 620 is maintained in the holding capacitor 630, sequentially writes the first and second signal electric potentials included in the data signal to one end of the holding capacitor 630. Here, the writing transistor 610 is an example of a writing transistor according to an embodiment of the present invention.

The driving transistor 620 outputs a signal current to the light emitting device 640 based on the signal voltage maintained in the holding capacitor 630 in accordance with the first and second signal electric potentials for allowing the light emitting device 640 to emit light. This driving transistor 620, in the state in which the power source electric potential used for driving the driving transistor 620 is applied through the power source line (DSL) 410, outputs a signal current corresponding to the signal voltage maintained in the holding capacitor 630 to the light emitting device 640. Here, the driving transistor 620 is an example of a driving transistor according to an embodiment of the present invention.

The holding capacitor 630 is used for maintaining a voltage corresponding to the data signal supplied by the writing transistor 610. In other words, the holding capacitor 630 achieves the function of maintaining the signal voltage corresponding to the first and second signal electric potentials written by the writing transistor 610. Here, the holding capacitor 630 is an example of a holding capacitor according to an embodiment of the present invention.

The light emitting device 640 emits light in accordance with the magnitude of the signal current that is output from the driving transistor 620. This light emitting device 640, for example, maybe implemented by an organic EL device. Here, the light emitting device 640 is an example of alight emitting device according to an embodiment of the present invention.

In this example, a case where the writing transistor 610 and the driving transistor 620 are n-channel transistors is assumed in the description. However, an embodiment of the present invention is not limited thereto. Such a transistor maybe an enhancement type, a depression type, or a dual-gate type.

In addition, here, a configuration example of the pixel circuit 600 in which the signal current is supplied to the light emitting device 640 by two transistors 610 and 620 and one holding capacitor 630 has been described. However, an embodiment of the present invention is not limited thereto. In other words, any configuration in which the driving transistor 620 and the light emitting device 640 are included maybe used. Next, an operation example of the above-described pixel circuit 600 will be described in detail with reference to a drawing.

### [Operation Example of Pixel Circuit 600]

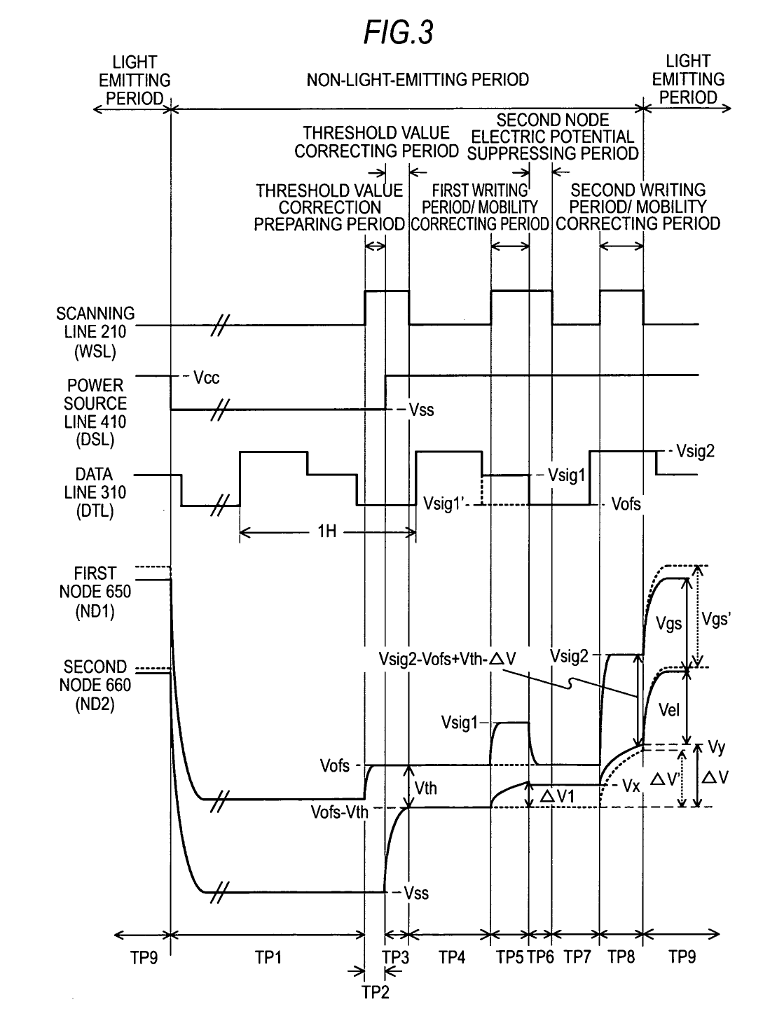

FIG. 3 is a timing chart of an operation example of the pixel circuit 600 according to the first embodiment of the present invention. Here, changes in the electric potentials of the scanning line (WSL) 210, the power source line (DSL) 410, the data line (DTL) 310, the first node (ND1) 650, and the second node (ND2) 660 are represented with a horizontal axis set as the time axis used in common.

Here, a horizontal scanning period (1H) that is a period for scanning the pixel circuit 600 in units of one row is represented. To the data line (DTL) 310 during the horizontal scanning period (1H), in order to increase the number of gray scales of the luminance to be greater than the number of steps of the signal electric potentials, two electric potentials including the first and second signal electric potentials (Vsig1 and Vsig2) are set.

In this example, the operation of the pixel circuit 600 for a case where the first signal electric potential (Vsig1) that is higher than the reference electric potential (Vofs) is supplied is denoted by a solid line. In addition, the operation of the pixel circuit 600 for a case where the first signal electric potential (Vsig1′) that has the same level as that of the reference electric potential (Vofs) is supplied is denoted by a dotted line.

In this timing chart, for convenience of the description, the transition in the operation of the pixel circuit 600 is delimited by periods of TP1 to TP9. First, in the light emitting period TP9, the light emitting device 640 is in a light emitting state. Immediately before completion of the light emitting period TP9, the electric potential of the scanning signal of the scanning line (WSL) 210 is set to an L (Low) level, and the electric potential of the power source signal of the power source line (DSL) 410 is set to the power source electric potential (Vcc).

Thereafter, a new field is started in the line-sequentially scanning. During a period TP1, the electric potential of the power source line (DSL) 410 is set to an initialization electric potential (Vss) that is used for initializing the second node (ND2) 660. Accordingly, since the electric potential of the second node (ND2) 660 decreases down to the initialization electric potential (Vss), the light emitting device 640 becomes in a non-light-emitting state. In addition, the electric potential of the first node (ND1) 650 is also decreased so as to follow the decrease in the electric potential of the second node (ND2) 660.

Subsequently, in a threshold value correction preparing period TP2, the electric potential of the scanning line (WSL) 210 is set to an H (High) level. Accordingly, the electric potential of the first node (ND1) 650, that is, the electric potential of one end of the holding capacitor 630 is initialized by being fixed to the reference electric potential (Vofs). As above, as the electric potentials of the first node (ND1) 650 and the second node (ND2) 660 are initialized, the preparation of a threshold value correcting operation is completed.

Next, during a threshold value correcting period TP3, a threshold value correcting operation is performed for eliminating variations in the threshold voltages of the driving transistors 620 of the pixel circuits 600. As the electric potential of the power source line (DSL) 410 is set to the power source electric potential (Vcc), a voltage (Vth) corresponding to the threshold voltage of the driving transistor 620 is maintained between the first node (ND1) 650 and the second node (ND2) 660. In other words, the voltage (Vth) corresponding to the threshold voltage of the driving transistor 620 is maintained in the holding capacitor 630.

Thereafter, during a period TP4, after the electric potential of the scanning signal supplied to the scanning line (WSL) 210 is transited to the L level, the second signal electric potential (Vsig2) included in the data signal of the data line (DTL) 310 is switched to the first signal electric potential (Vsig1).

Next, during a first writing period/a mobility correcting period TP5, as the electric potential of the scanning signal of the scanning line (WSL) 210 is switched to the H level, the electric potential of the first node (ND1) 650 rises up to the first signal electric potential (Vsig1). In other words, the first signal electric potential (Vsig1) is written into the first node (ND1) 650 by the writing transistor 610.

On the other hand, since a current corresponding to the mobility of the driving transistor 620 at the first signal electric potential (Vsig1) is supplied to the second node (ND2) 660, the electric potential of the second node (ND2) 660 rises by a first correction amount (ΔV1) with respect to the threshold electric potential (Vofs−Vth). In other words, by performing a mobility correcting operation for correcting the mobility of the driving transistor 620, the electric potential of the second node (ND2) 660 rises by the first correction amount (ΔV1) with respect to the threshold electric potential (Vofs−Vth).

In contrast, when the first signal electric potential (Vsig1′) denoted by a broken line is supplied, the electric potential of the first node (ND1) 650 is maintained at the reference electric potential (Vofs) during the first writing period/the mobility correcting period TP5. Accordingly, the electric potential of the second node (ND2) 660 is also maintained at the threshold electric potential (Vofs−Vth).

Thereafter, during a second node electric potential suppressing period TP6, as the electric potential of the data signal of the data line (DTL) 310 is switched to the reference electric potential (Vofs), the electric potential of the first node (ND1) 650 decreases to the reference electric potential (Vofs) from the first signal electric potential (Vsig1). At this time, due to coupling of the holding capacitor 630, the electric potential of the second node (ND2) 660 slightly decreases to “Vx”.

At this time, since a difference in the electric potentials of the first node (ND1) 650 and the second node (ND2) 660 is smaller than the voltage (Vth) corresponding to the threshold voltage of the driving transistor 620, the electric potential of the second node (ND2) 660 is maintained at “Vx”. As above, by disposing the second node electric potential suppressing period TP6, the variation in the second node (ND2) 660 due to the response characteristics acquired when the data signal is switched from the first signal electric potential (Vsig1) to the second signal electric potential (Vsig2) can be eliminated.

Here, an example in which the reference electric potential (Vofs) is supplied as a data signal during the second node electric potential suppressing period TP6 is represented: However, an embodiment of the present invention is not limited thereto. In this case, in order not to allow the electric potential of the second node (ND2) 660 to rise during a period TP7, an electric potential that allows the voltage maintained in the holding capacitor 630 to be equal to or smaller than the voltage (Vth) corresponding to the threshold voltage of the driving transistor 620 may be supplied to one end of the holding capacitor 630. Accordingly, until the second signal electric potential (Vsig2) is generated after the first signal electric potential (Vsig1) is generated, the horizontal selector (HSEL) 300 may be configured to select an electric potential that allows the voltage of the holding capacitor 630 to be equal to or lower than the voltage (Vth).

Thereafter, during the period TP7, after the electric potential of the scanning signal of the scanning line (WSL) 210 is set to the L level, the electric potential of the data signal of the data line (DTL) 310 is switched from the reference electric potential (Vofs) to the second signal electric potential (Vsig2).

Subsequently, during a second writing period/a mobility correcting period TP8, the electric potential of the scanning signal of the scanning line (WSL) 210 is switched to the H level. Accordingly, the electric potential of the first node (ND1) 650 rises up to the second signal electric potential (Vsig2). In other words, the second signal electric potential (Vsig2) is written into the first node (ND1) 650 by the writing transistor 610.

At this time, the electric potential of the second node (ND2) 660 rises from the electric potential (Vx) at the time of completion of the period TP7 corresponding to the mobility of the driving transistor 620 at the first signal electric potential (Vsig1) to a mobility correcting electric potential (Vy). In other words, the electric potential of the second node (ND2) 660 rises by a rising amount (ΔV) according to a mobility correcting operation at the first and second signal electric potentials (Vsig1 and Vsig2) with respect to the threshold electric potential (Vofs−Vth) acquired by performing the threshold value correcting operation. Accordingly, “Vsig2−((Vofs−Vth)+ΔV)” is maintained in the holding capacitor 630 as a signal voltage corresponding to the first and second signal electric potentials.

Thereafter, during the light emitting period TP9, after the electric potential of the scanning signal of the scanning line (WSL) 210 is switched to the L level, the data signal of the data line (DTL) 310 is set to the reference electric potential (Vofs). Accordingly, the light emitting device 640 emits light with luminance corresponding to the signal voltage (Vsig2−Vofs+Vth−ΔV) that is applied to the holding capacitor 630. In this case, the signal voltage (Vsig2−Vofs+Vth−ΔV) applied to the holding capacitor 630 is adjusted in accordance with the voltage (Vth) corresponding to the threshold voltage and the rising amount (ΔV) acquired by performing the mobility correcting operation. Therefore, the influence of the variations in the threshold voltage and the mobility of the driving transistor 620 are eliminated from the luminance of the light emitting device 640.

In addition, during a period in the middle of the light emitting period TP9, the electric potentials of the first node (ND1) 650 and the second node (ND2) 660 rise. At this time, the signal voltage (Vsig2−Vofs+Vth−ΔV) at the time of completion of the second writing period/the mobility correcting period TP8 is maintained in the holding capacitor 630 as the signal voltage (Vgs).

In contrast, when the first signal electric potential (Vsig1′) denoted by a broken line is supplied, during the second writing period/the mobility correcting period TP8, the electric potential of the first node (ND1) 650 rises up to the second signal electric potential (Vsig2). On the other hand, the electric potential of the second node (ND2) 660 rises by the rising amount (ΔV′) acquired by performing the mobility correcting operation with respect to the threshold electric potential (Vofs−Vth) at the time of completion of the period TP7. Accordingly, a voltage “Vsig2−((Vofs−Vth)+αV′)” is maintained in the holding capacitor 630 as a signal voltage corresponding only to the second signal electric potential (Vsig2).

Thereafter, during the light emitting period TP9 at a time when the first signal electric potential (Vsig1′) denoted by a broken line is supplied, the light emitting device 640 emits light with luminance corresponding to the signal voltage (Vsig2−Vofs+Vth−ΔV′) that is applied to the holding capacitor 630. In addition, during a period in the middle of this light emitting period TP9, the electric potentials of the first node (ND1) 650 and the second node (ND2) 660 rise. At this time, the signal voltage (Vsig2−Vofs+Vth−ΔV′) at the time of completion of the second writing period/the mobility correcting period TP8 is maintained in the holding capacitor 630 as the signal voltage (Vgs′). In other words, when the first signal electric potential (Vsig1′) denoted by a broken line is supplied, similarly to a general pixel circuit, the signal voltage (Vgs′) is maintained in the holding capacitor 630 by performing the writing operation and mobility correcting operation once, whereby the light emitting device 640 emits light.

As above, by disposing the first writing period/the mobility correcting period TP5, a current corresponding to the mobility of the driving transistor 620 at the first signal electric potential (Vsig1) can be supplied to the other end of the holding capacitor 630. Accordingly, since the electric potential of the second node (ND2) 660 can be allowed to rise to be higher than the threshold electric potential (Vofs−Vth), the signal voltage (Vgs) maintained in the holding capacitor 630 during the second writing period/the mobility correcting period TP8 can decrease to be smaller than “Vgs′”.

In other words, since the magnitude of the signal voltage (Vgs) changes in accordance with the magnitude of the first signal electric potential (Vsig1), the magnitude of the signal voltage (Vgs) maintained in the holding capacitor 630 can be adjusted by controlling the magnitude of the first signal electric potential (Vsig1). Accordingly, as the control signal used for supplying the first and second signal electric potentials (Vsig1 and Vsig2) to the pixel circuit 600 is generated by the write scanner (WSCN) 200, the number of gray scales of the luminance of the pixel circuit 600 can be increased.

In addition, in this case, as the first signal electric potential (Vsig1) increases, the first correction amount (ΔV1) acquired by performing the mobility correcting operation increases. However, the electric potential rising rate of the first correction amount (ΔV1) per the time unit also increases. In other words, when the first signal electric potential (Vsig1) is set to a value that is higher than the second signal electric potential (Vsig2), the accuracy of setting the first signal electric potential (Vsig1) has a great influence on the accuracy of setting the signal voltage set in the holding capacitor 630.

Accordingly, by setting the first signal electric potential (Vsig1) to be equal to or lower than the second signal electric potential (Vsig2), an excessive increase in the first correction amount (ΔV1) that is acquired by performing the mobility correcting operation during the first writing period/the mobility correcting period can be suppressed. In other words, degradation of the accuracy of the representation of a gray scale due to the accuracy of setting the first signal electric potential (Vsig1) can be decreased. However, even in such a case, compared to a case where the first signal electric potential (Vsig1) is set to the reference electric potential (Vofs), error from the original luminance of light emission may be increased.

### [Transition in Operation of Pixel Circuit 600]

Next, the transition in the operation state of the pixel circuit 600 according to the first embodiment of the present invention will be described below in detail with reference to drawings. Here, the operation states of the pixel circuit 600 corresponding to the periods TP1 to TP9 of the timing chart that are denoted by solid lines in FIG. 3 are represented. In describing the operation states of the pixel circuit 600, for convenience of the description, parasitic capacitance 641 of the light emitting device 640 is shown, the writing transistor 610 is represented as a switch, and the scanning line (WSL) 210 is not shown in the drawings.

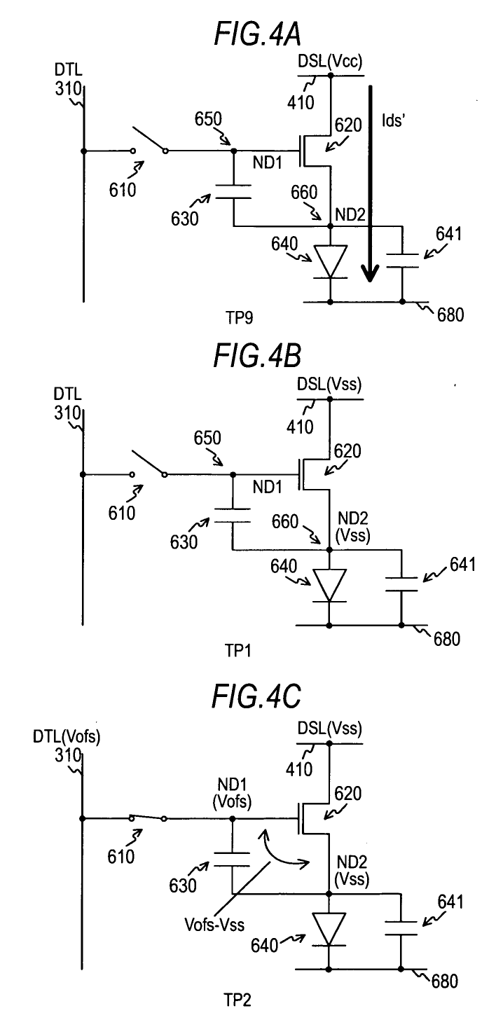

FIGS. 4A to 4C are schematic circuit diagrams representing the operation states of the pixel circuit 600 corresponding to the periods TP9, TP1, and TP2. During the light emitting period TP9, as shown in FIG. 4A, the writing transistor 610 is in the Off (non-conductive) state, and a state in which the power source electric potential (Vcc) is applied to the power source line (DSL) 410 is formed. Since a signal current (Ids′) is supplied from the driving transistor 620 to the light emitting device 640, the light emitting device 640 emits light with luminance corresponding to the signal current (Ids′).

Next, during the period TP1, as shown in FIG. 4B, the electric potential of the power source line (DSL) 410 transits from the power source electric potential (Vcc) to the initialization electric potential (Vss). Accordingly, since the electric potential of the second node (ND2) 660 decreases down to the initialization electric potential (Vss), the light emitting device 640 becomes in the non-light-emitting state. In other words, by switching the electric potential of the power source line (DSL) 410 to the initialization electric potential (Vss), the second node (ND2) 660 is initialized to the initialization electric potential (Vss). At this time, since the first node (ND1) 650 is in the floating state, the electric potential of the first node (ND1) 650 decreases so as to follow the decrease in the electric potential of the second node (ND2) 660 due to coupling of the holding capacitor 630.

Subsequently, during the threshold value correction preparing period TP2, as shown in FIG. 4C, as the electric potential of the scanning line (WSL) 210 transits to the H level, the writing transistor 610 becomes in the On (conductive) state. Accordingly, the electric potential of the first node (ND1) 650 is initialized to the reference electric potential (Vofs) of the data line (DTL) 310.

Accordingly, an electric potential difference between the first node (ND1) 650 and the second node (ND2) 660 becomes “Vofs−Vss”. Here, it is assumed that the initialization electric potential (Vss) of the power source line (DSL) 410 is set to an electric potential that is sufficiently lower than the reference electric potential (Vofs).

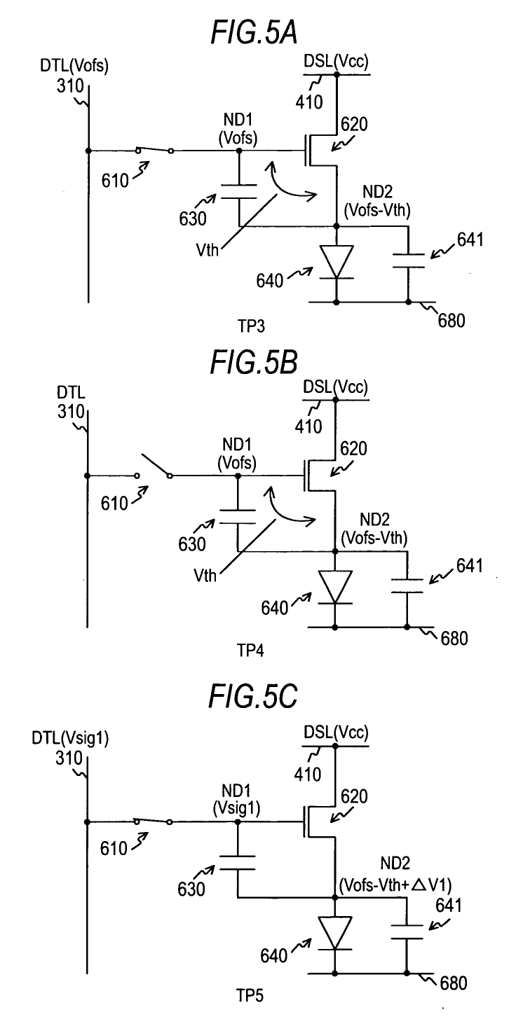

FIGS. 5A to 5C are schematic circuit diagrams representing the operation states of the pixel circuit 600 corresponding to the periods TP3 to TP5.

After the threshold value correction preparing period TP2, during the threshold value correcting period TP3, as shown in FIG. 5A, the electric potential of the power source line (DSL) 410 transits to the power source electric potential (Vcc). Accordingly, by supplying a current from the driving transistor 620 to the second node (ND2) 660, the electric potential of the second node (ND2) 660 rises. Then, after a predetermined time elapses, the electric potential difference between the first node (ND1) 650 and the second node (ND2) 660 becomes an electric potential difference (Vth) corresponding to the threshold voltage of the driving transistor 620.

Accordingly, the voltage (Vth) corresponding to the threshold voltage of the driving transistor 620 is applied to the holding capacitor 630 with the reference electric potential (Vofs) applied to the one end of the holding capacitor 630 used as a reference. In other words, this is the threshold value correcting operation. Here, it is assumed that the cathode electric potential (Vcat) of a cathode line 680 and the reference electric potential (Vofs) of the data line (DTL) 310 are set in advance such that a current output from the driving transistor 620 does not flow through the light emitting device 640.

Next, during the period TP4, as shown in FIG. 5B, as the electric potential of the scanning signal supplied from the scanning line (WSL) 210 transits to the L level, the writing transistor 610 becomes in the Off state. After being switched from the reference electric potential (Vofs) to the second signal electric potential (Vsig2), the electric potential of the data signal of the data line (DTL) 310 is set to the first signal electric potential (Vsig1).

Subsequently, during the first writing period/the mobility correcting period TP5, as shown in FIG. 5C, as the electric potential of the scanning signal of the scanning line (WSL) 210 transits to the H level, the writing transistor 610 becomes in the On state. Accordingly, since the first signal electric potential (Vsig1) is written into the one end of the holding capacitor 630 by the writing transistor 610, the electric potential of the first node (ND1) 650 is set to the first signal electric potential (Vsig1).

In addition, a current corresponding to the mobility of the driving transistor 620 at the first signal electric potential (Vsig1) is supplied from the driving transistor 620 to the other electrode of the holding capacitor 630 and the parasitic capacitance 641 of the light emitting device 640. Accordingly, the holding capacitor 630 and the parasitic capacitance 641 start to be charged, and the electric potential of the second node (ND2) 660 rises by the first correction amount (ΔV1) with respect to the threshold electric potential (Vofs−Vth).

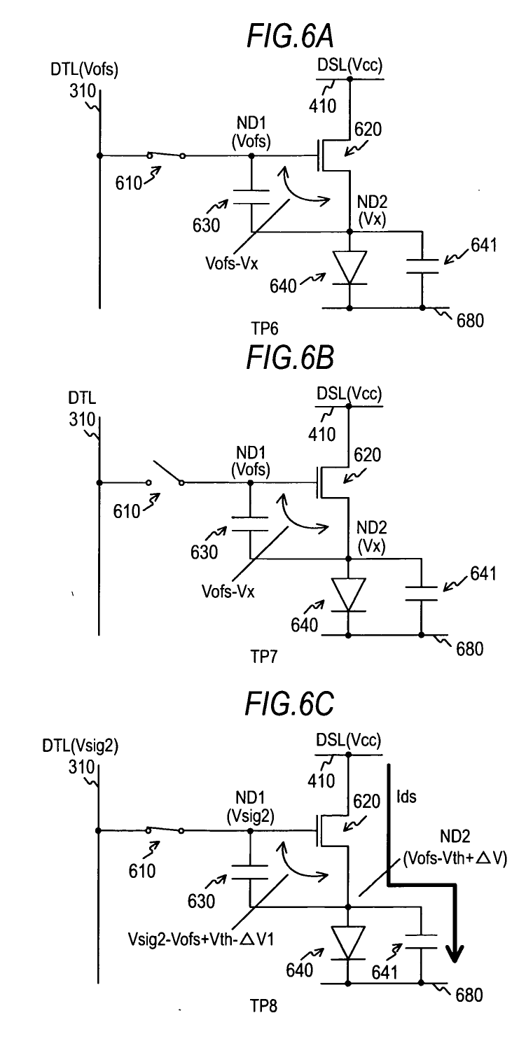

FIGS. 6A to 6C are schematic circuit diagrams representing the operation states of the pixel circuit 600 corresponding to the periods TP6 to TP8.

After the first writing period/the mobility correcting period TP5, during the second node electric potential suppressing period TP6, as shown in FIG. 6A, the electric potential of the data signal of the data line (DTL) 310 is switched from the first signal electric potential (Vsig1) to the reference electric potential (Vofs). Accordingly, the electric potential of the first node (ND1) 650 decreases from the first signal electric potential (Vsig1) down to the reference electric potential (Vofs). In accordance with the decrease in the electric potential, the electric potential of the second node (ND2) 660 slightly decreases to be “Vx” due to the influence of coupling of the holding capacitor 630.

Then, during the period TP7, as shown in FIG. 6B, the electric potential of the scanning signal supplied from the scanning line (WSL) 210 transits to the L level, the writing transistor 610 becomes in the Off state. Accordingly, the first node (ND1) 650 becomes in the floating state. However, the electric potentials of the first node (ND1) 650 and the second node (ND2) 660 hardly change. The reason for this is that the electric potential difference (Vofs−Vx) of the first node (ND1) 650 and the second node (ND2) 660 is smaller than the voltage (Vth) corresponding to the threshold voltage of the driving transistor 620.

Subsequently, during the second writing period/the mobility correcting period TP8, as shown in FIG. 6C, as the electric potential of the scanning signal of the scanning line (WSL) 210 transits to the H level, the writing transistor 610 becomes in the On state. Accordingly, since the second signal electric potential (Vsig2) is written into the one end of the holding capacitor 630 by the writing transistor 610, the electric potential of the first node (ND1) 650 is set to the second signal electric potential (Vsig2).

In addition, a current corresponding to the mobility of the driving transistor 620 at the second signal electric potential (Vsig2) is supplied from the driving transistor 620 to the other electrode of the holding capacitor 630 and the parasitic capacitance 641 of the light emitting device 640. Accordingly, the holding capacitor 630 and the parasitic capacitance 641 start to be charged, and the electric potential of the second node (ND2) 660 rises by the rising amount (ΔV) due to the mobility correction with respect to the reference electric potential (Vofs−Vth).

Accordingly, an electric potential difference between the first node (ND1) 650 and the second node (ND2) 660 becomes “Vsig2−Vofs+Vth−ΔV”. As described above, the rising amount (ΔV) is adjusted by performing writing of the second signal electric potential (Vsig2) and performing the mobility correcting operation twice. Accordingly, the variations in the threshold voltages and the mobility of the driving transistor of each pixel circuit are eliminated.

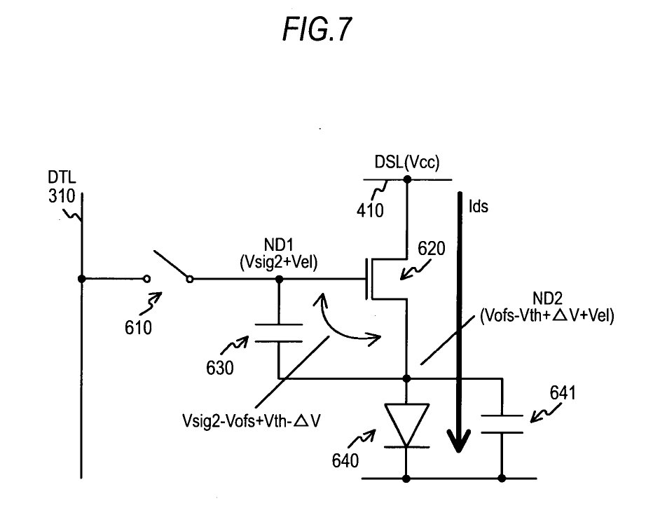

FIG. 7 is a schematic circuit diagram representing the operation state of the pixel circuit 600 corresponding to the period TP9.

During the light emitting period TP9, as shown in FIG. 7, as the electric potential of the scanning signal of the scanning line (WSL) 210 transits to the L level, the writing transistor 610 becomes in the Off state. Accordingly, the electric potential of the second node (ND2) 660 rises in accordance with the signal current (Ids) of the driving transistor 620, and the electric potential of the first node (ND1) 650 also rises in a coupled manner due to the coupling through the holding capacitor 630. At this time, an electric potential difference (Vsig2−Vofs+Vth−ΔV) between the first node (ND1) 650 and the second node (ND2) 660 is maintained.

### [Example of Correspondence Relationship Between First and Second Signal Electric Potentials and Pixel Circuit 600]

Next, the luminance of light emission of the pixel circuit 600 that corresponds to the first and second signal electric potentials (Vsig1 and Vsig2) generated by the signal electric potential generating unit 120 according to the first embodiment of the present invention will be described below with reference to drawings.

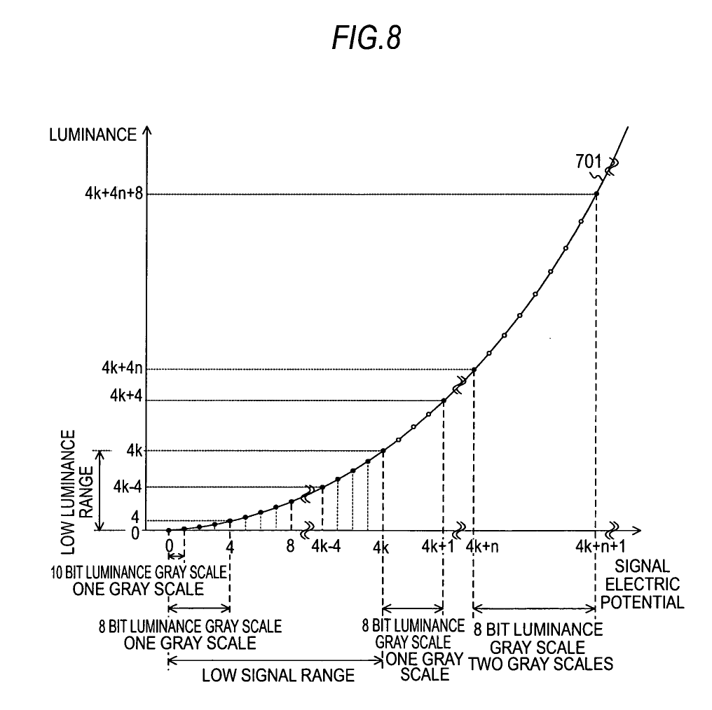

FIG. 8 is a diagram representing an example of the correspondence relationship between the second signal electric potential (Vsig2) supplied to a pixel circuit 600 according to the first embodiment of the present invention and the luminance of the pixel circuit 600. Here, it is assumed that the number of gray scales of the luminance of the pixel circuit 600 is set to 10 bits by generating the first and second signal electric potentials (Vsig1 and Vsig2) through the number of steps of 8 bits by using the signal electric potential generating unit 120.

Here, a gamma curve 701 that represents the correspondence relationship between the second signal electric potential (Vsig2) and the luminance of the pixel circuit 600 is shown. The number of gray scales of the luminance is represented as the magnitude of the luminance of the pixel circuit 600 in the vertical axis, and the number of steps of the signal electric potential as the magnitude of the second signal electric potential (Vsig2) is represented in the horizontal axis.

Black circles disposed on the gamma curve 701 mean that a signal voltage is set to the holding capacitor 630 by setting the first signal electric potential (Vsig1) to an electric potential, which is the same as the reference electric potential (Vofs), and controlling only the second signal electric potential (Vsig2). In addition, white circles disposed on the gamma curve 701 mean that the first signal electric potential (Vsig1) is set to be higher than the reference electric potential (Vofs) and be equal to or lower than the second signal electric potential (Vsig2). In other words, with the white circles disposed on the gamma curve 701, the gray scales of the luminance between the black circles disposed on the gamma curve 701 are interpolated.

In this example, it is apparent that, as the luminance of the pixel circuit 600 is lowered, a larger number of the black circles on the gamma curve 701 are assigned. In other words, in order to allow the pixel circuit 600 to emit light with a more accurate luminance level as the luminance is closer to a black display level, the signal electric potential generating unit 120 sets the signal voltage (Vgs′) to the holding capacitor 630 by controlling only the second signal electric potential (Vsig2). This is in consideration of human visual characteristics in which the sensitivity is higher for lower luminance than for higher luminance.

In particular, for a low signal range (Steps 0 to 4 k) corresponding to a low luminance range of luminance gray scales 0 to 4 k, the signal electric potential generating unit 120 generates the second signal electric potential (Vsig2) with a step width corresponding to one gray scale of 10-bit luminance gray scales. In addition, it is preferable that this low signal range is set to be 1/10 of the entire range of the second signal electric potential (Vsig2).

In addition, the signal electric potential generating unit 120 arranges a step width corresponding to one gray scale of the 8-bit luminance gray scale as a step width between Steps 4 k and 4 k+1. In addition, the signal electric potential generating unit 120 arranges a step width corresponding to two gray scales of the 8-bit luminance gray scale as a step width between Steps 4 k+n and 4 k+n+1.

As above, by decreasing the step width of the second signal electric potential (Vsig2) as the electric potential of the second signal electric potential (Vsig2) decreases, the signal electric potential generating unit 120 can allow the pixel circuit 600 to emit light with high accuracy in a low luminance range in which the luminance is low.

In addition, by increasing the number of steps of the second signal electric potential (Vsig2) that are assigned in the low signal range and increasing the step width of the second signal electric potential (Vsig2) as the signal electric potential increases, a total number of steps of the signal electric potential can be set to the number of steps of 8 bits. In other words, the steps of the second signal electric potential (Vsig2) are assigned at a step interval of 10 bits for low luminance but are assigned at a step interval of 8 bits or less for high luminance. Accordingly, gray scales of the luminance of 10 bits can be implemented by using the number of steps of the signal electric potential of 8 bits.

### [Example of Setting First and Second Signal Electric Potentials]

Next, an example of generation of the first and second signal electric potentials (Vsig1 and Vsig2) relating to a part of the correspondence relationship shown in FIG. 8 will be described below with reference to drawings.

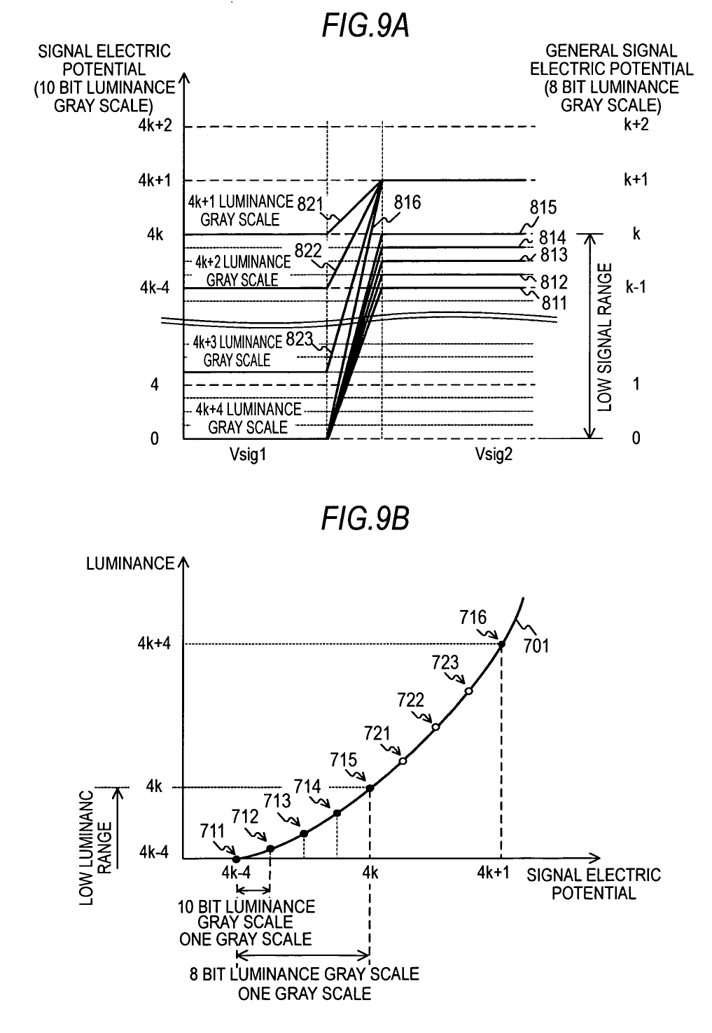

FIGS. 9A and 9B are diagrams relating to an example of setting the first and second signal electric potentials (Vsig1 and Vsig2) corresponding to the luminance gray scales of 4 k−4 to 4 k+4 shown in FIG. 8.

FIG. 9A is a conceptual diagram representing a combination of the first and second signal electric potentials (Vsig1 and Vsig2) corresponding to the luminance gray scales 4 k−4 to 4 k+4 shown in FIG. 8. FIG. 9B is a diagram representing the luminance gray scales of the pixel circuit 600 that correspond to the first and second signal electric potentials (Vsig1 and Vsig2) shown in FIG. 9A.

FIG. 9A represents the signal electric potential characteristics 811 to 816 and 821 to 823 that are generated by the signal electric potential generating unit 120. Here, in the vertical axis, as the magnitude of the first and second signal electric potentials (Vsig1 and Vsig2), the number of steps is represented. In addition, as a reference, the number of steps of signal electric potentials in a general 8-bit luminance gray scale is represented. Here, Step 0 of the signal electric potential is assumed to be an electric potential that is the same as the reference electric potential (Vofs).

In the signal electric potential characteristics 811 to 816, after the first signal electric potential (Vsig1) is set to Step 0, the second signal electric potentials (Vsig2) are set to Steps 4 k−4 to 4 k+1. In other words, the second signal electric potential (Vsig2) is set to an electric potential corresponding to a video signal that represents the luminance of light emission of the pixel circuit 600. Accordingly, since the signal voltage (Vgs′) is set by controlling only the second signal electric potential (Vsig2), the pixel circuit 600 can emit light with high accuracy.

In the signal electric potential characteristic 821, after the first signal electric potential (Vsig1) is set to Step 4 k, the second signal electric potential (Vsig2) is set to Step 4 k+1. On the other hand, in the signal electric potential characteristic 822, after the first signal electric potential (Vsig1) is set to Step 4 k−4, the second signal electric potential (Vsig2) is set to Step 4 k+1. Furthermore, in the signal electric potential characteristic 823, after the first signal electric potential (Vsig1) is set to Step 5, the second signal electric potential (Vsig2) is set to Step 4 k+1.

FIG. 9B represents the luminance gray scales corresponding to the signal electric potential characteristics 811 to 816 and 821 to 823. Here, similarly to FIG. 8, the number of luminance gray scales is represented as the magnitude of the luminance of the pixel circuit 600 in the vertical axis, and the number of steps of the signal electric potential as the magnitude of the second signal electric potential (Vsig2) is represented in the horizontal axis.

In this example, black circles 711 to 716 and white circles 721 to 723 corresponding respectively to the luminance gray scales 4 k−4 to 4 k+4 represented in FIG. 8 are shown. The black circles 711 to 716 and the white circles 721 to 723 represent the correspondence relationship between the signal electric potential characteristics 811 to 816 and 821 to 823 and the luminance level of the pixel circuit 600.

As above, by decreasing the step width of the second signal electric potential (Vsig2) in the low signal range, compared to the step width of the signal electric potential of a general 8-bit luminance gray scale, the second signal electric potential (Vsig2) can be generated. Accordingly, since the signal voltage in the holding capacitor 630 can be set by controlling only the second signal electric potential (Vsig2), degradation of accuracy of the representation of the luminance gray scales in the low luminance range can be prevented.

In addition, by setting the first signal electric potential (Vsig1) as the signal electric potential characteristics 821 to 823, a space between the black circles 715 and 716 can be interpolated with the white circles 721 to 723. In such a case, since the first signal electric potential (Vsig1) can be set to an electric potential that is lower than the second signal electric potential (Vsig2), an excessive increase in the rising amount (ΔV) due to correction of the mobility can be suppressed.

Furthermore, since many steps can be assigned to signal electric potentials that are lower than the second signal electric potential (Vsig2), the first signal electric potential (Vsig1) can be set with higher accuracy. Accordingly, a decrease in the accuracy of setting that occurs due to a combination of the first and second signal electric potentials (Vsig1 and Vsig2) can be reduced. Therefore, the number of the gray scales of the luminance can be increased to 10 bits while suppressing occurrence of defects in the image quality such as stripes and unevenness.

Here, as the electric potential of Step 0 that is set as the first signal electric potential (Vsig1) in the low signal range, the reference electric potential (Vofs) is assumed. However, the electric potential of Step 0 may be set such that the first correction amount (ΔV1) hardly increases during the first writing period/the mobility correcting period. In other words, the first signal electric potential (Vsig1) in the low signal range may be set to an electric potential for which supply of a current corresponding to the mobility of the driving transistor 620 to the other end of the holding capacitor 630 from the driving transistor 620 is suppressed. Accordingly, the electric potential of Step 0 of the signal electric potential may be set to the electric potential of a black display level.

In addition, here, an example in which the first signal electric potential (Vsig1) in the lower luminance range is set to the reference electric potential (Vofs) has been described. However, the first signal electric potential (Vsig1) may be set to an electric potential that is the same as the second signal electric potential (Vsig2). Setting the first and second signal electric potentials (Vsig1 and Vsig2) to be the same is equivalent to dividing performing a writing operation once and performing a mobility correcting operation, which is a general case, into two. Accordingly, even in a case where the first and second signal electric potentials (Vsig1 and Vsig2) are set to be the same in the low luminance range, the pixel circuit 600 can emit light with high accuracy.

### [Modified Example of Setting First and Second Signal Electric Potentials]

Next, as a modified example of setting the first and second signal electric potentials (Vsig1 and Vsig2), an example in which the first and second signal electric potentials (Vsig1 and Vsig2) are set to be the same in the low luminance range will be described below with reference to drawings.

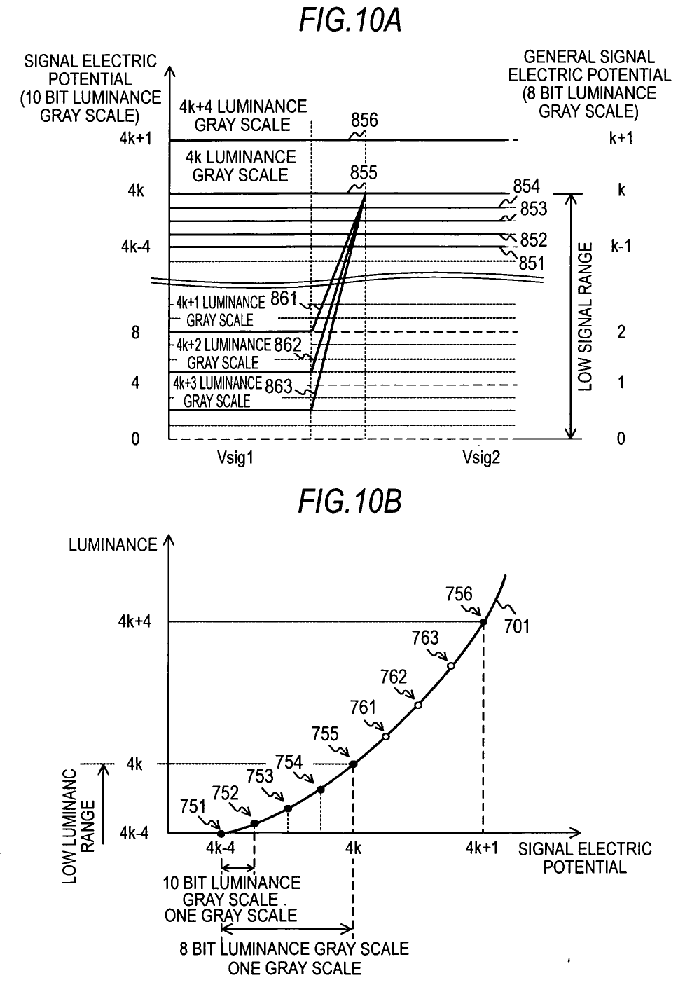

FIGS. 10A and 10B are diagrams relating to a modified example of setting the first and second signal electric potentials (Vsig1 and Vsig2) corresponding to the luminance gray scales of 4 k−4 to 4 k+4 shown in FIG. 8.

FIG. 10A is a conceptual diagram representing a combination of the first and second signal electric potentials (Vsig1 and Vsig2) corresponding to the luminance gray scales 4 k−4 to 4 k+4 shown in FIG. 8. FIG. 10B is a diagram representing the luminance gray scales of the pixel circuit 600 that correspond to the first and second signal electric potentials (Vsig1 and Vsig2) shown in FIG. 10A.

FIG. 10A represents the signal electric potential characteristics 851 to 856 and 861 to 863 that are generated by the signal electric potential generating unit 120. Here, in the vertical axis, the same as that of FIG. 9A is represented. Thus, the description thereof is omitted here.

In the signal electric potential characteristics 851 to 856, the first signal electric potential (Vsig1) is set to Steps 4 k−4 to 4 k+1 that are the same as those of the second signal electric potential (Vsig2). For example, in the signal electric potential characteristic 851, the first signal electric potential (Vsig1) is set to Step 4 k−4 that is the same as that of the second signal electric potential (Vsig2).

In the signal electric potential characteristic 861, after the first signal electric potential (Vsig1) is set to Step 8, the second signal electric potential (Vsig2) is sequentially set to Step 4 k. On the other hand, in the signal electric potential characteristic 862, after the first signal electric potential (Vsig1) is set to Step 5, the second signal electric potential (Vsig2) is sequentially set to Step 4 k. Furthermore, in the signal electric potential characteristic 863, after the first signal electric potential (Vsig1) is set to Step 2, the second signal electric potential (Vsig2) is sequentially set to Step 4 k.

FIG. 10B represents the luminance gray scales corresponding to the signal electric potential characteristics 851 to 856 and 861 to 863. Here, similarly to FIG. 8, the number of luminance gray scales is represented as the magnitude of the luminance of the pixel circuit 600 in the vertical axis, and the number of steps of the signal electric potential as the magnitude of the second signal electric potential (Vsig2) is represented in the horizontal axis.

In this example, black circles 751 to 756 and white circles 761 to 763 corresponding to the luminance gray scales 4 k−4 to 4 k+4 represented in FIG. 8 are shown. The black circles 751 to 756 and the white circles 761 to 763 represent the correspondence relationship between the signal electric potential characteristics 851 to 856 and 871 to 873 and the luminance level of the pixel circuit 600.

As above, even when the first and second signal electric potentials (Vsig1 and Vsig2) in the lower signal range are set to be the same, the first signal electric potentials (Vsig1) corresponding to the white circles 761 to 763 can be set to an electric potential that is equal to or lower than the second signal electric potential (Vsig2).

As above, according to the first embodiment of the present invention, the number of gray scales of the luminance of light emission of the light emitting device 640 can be increased by individually setting the first and second signal electric potentials (Vsig1 and Vsig2) by using the signal electric potential generating unit 120. In addition, by decreasing the step width of the signal electric potential as the second signal electric potential (Vsig2) decreases, the representation of gray scales for the lower luminance can be improved. Furthermore, since the first signal electric potential (Vsig1) in a higher luminance range other than the low luminance range can be set to be equal to or lower than the second signal electric potential (Vsig2), the accuracy of representation of the gray scale in the higher luminance range can be improved.

The display device 100 according to the first embodiment of the present invention may have a flat panel shape and can be applied to displays of various electronic apparatuses such as a digital camera, a notebook personal computer, a mobile phone, and a video camera. In addition, this display device 100 can be applied to each display of electronic apparatuses of all the fields, which display an image or a video based on a video signal input to the electronic apparatus or a video signal generated inside the electronic apparatus. Examples of the electronic apparatuses to which such a display device is applied will be represented below.

### 2. Second Embodiment

### [Examples Applied to Electronic Apparatus]

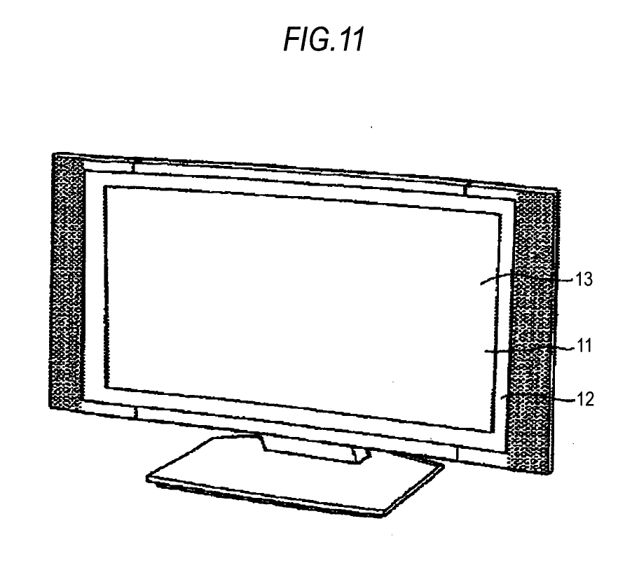

FIG. 11 is an example of a television set according to a second embodiment of the present invention. This television set is a television set to which the first embodiment of the present invention is applied. This television set includes a video display screen 11 that is configured by a front panel 12, a filter glass 13, and the like. The television set is manufactured by using the display device 100 according to the first embodiment of the present invention as the video display screen 11.

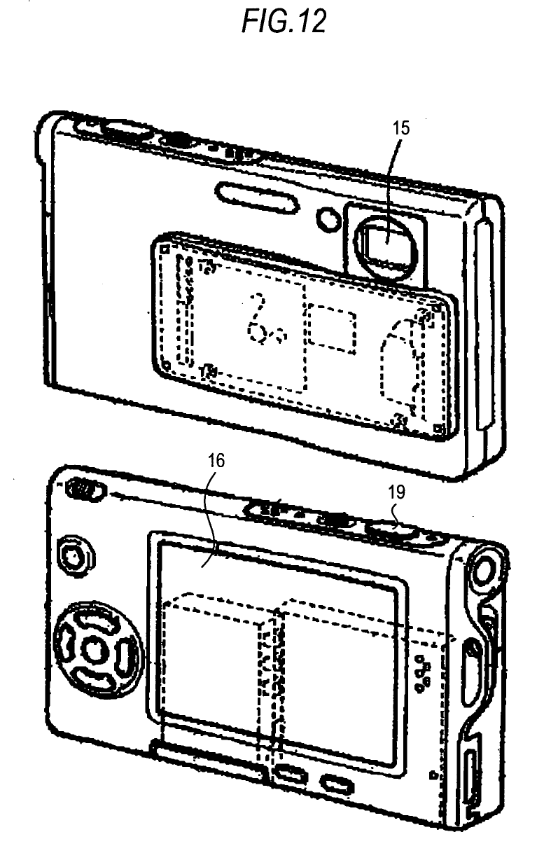

FIG. 12 is an example of a digital still camera according to the second embodiment of the present invention. This digital still camera is a digital still camera to which the first embodiment of the present invention is applied. Here, on the upper stage, a front view of the digital still camera is represented. In addition, on the lower stage, a rear view of the digital still camera is represented. This digital still camera includes an imaging lens 15, a display unit 16, control switches, menu switches, a shutter 19, and the like. The digital still camera is manufactured by using the display device 100 according to the first embodiment of the present invention as the display unit 16 thereof.

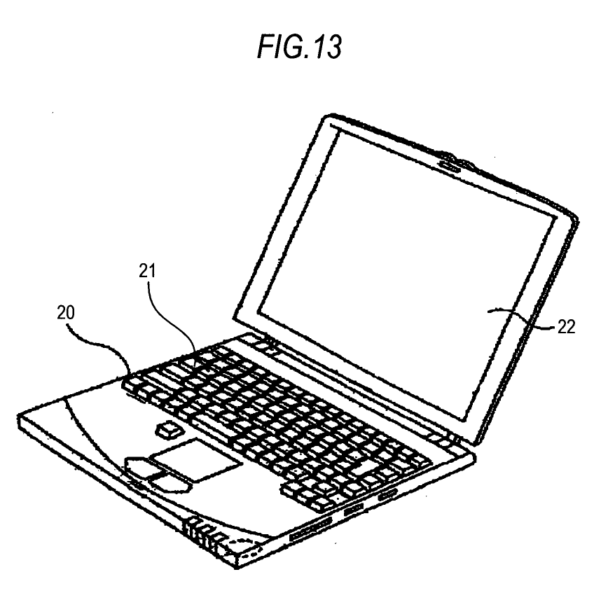

FIG. 13 is an example of a notebook personal computer according to the second embodiment of the present invention. This notebook personal computer is a notebook personal computer to which the first embodiment of the present invention is applied. This notebook personal computer includes a keyboard 21, which operates when a text or the like is input, in a main body 20. In addition, the notebook personal computer has a display unit 22, which displays an image, in a main body cover. The notebook personal computer is manufactured by using the display device 100 according to the first embodiment of the present invention as the display unit 22 thereof.

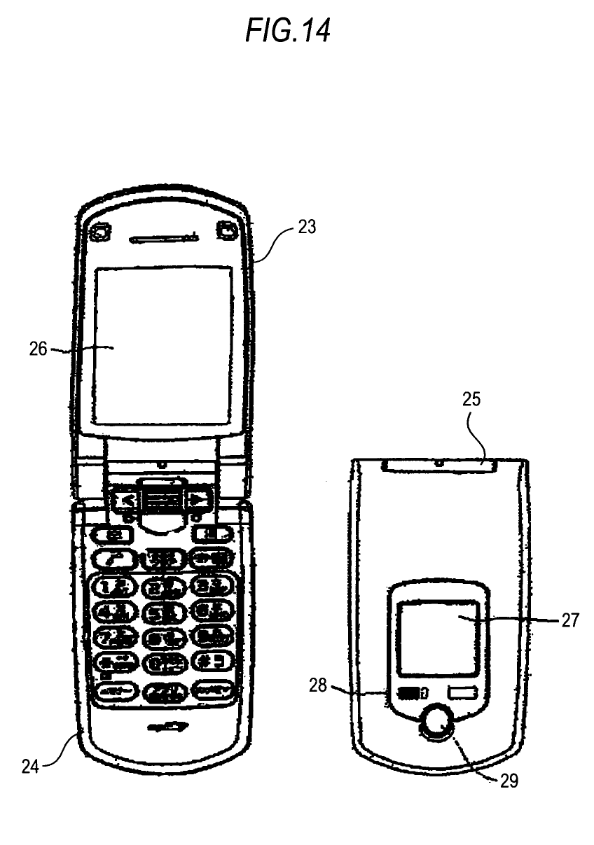

FIG. 14 is an example of a mobile terminal device according to the second embodiment of the present invention. This mobile terminal device is a mobile terminal device to which the first embodiment of the present invention is applied. Here, on the left side, a state in which the mobile terminal device is open is represented. In addition, on the right side, a state in which the mobile terminal device is closed is represented. This mobile terminal device includes an upper case 23, a lower case 24, a connection portion (here, a hinge portion) 25, a display 26, a sub display 27, a picture light 28, a camera 29, and the like. The mobile terminal device is manufactured by using the display device 100 according to the first embodiment of the present invention as the display 26 or the sub display 27 thereof.

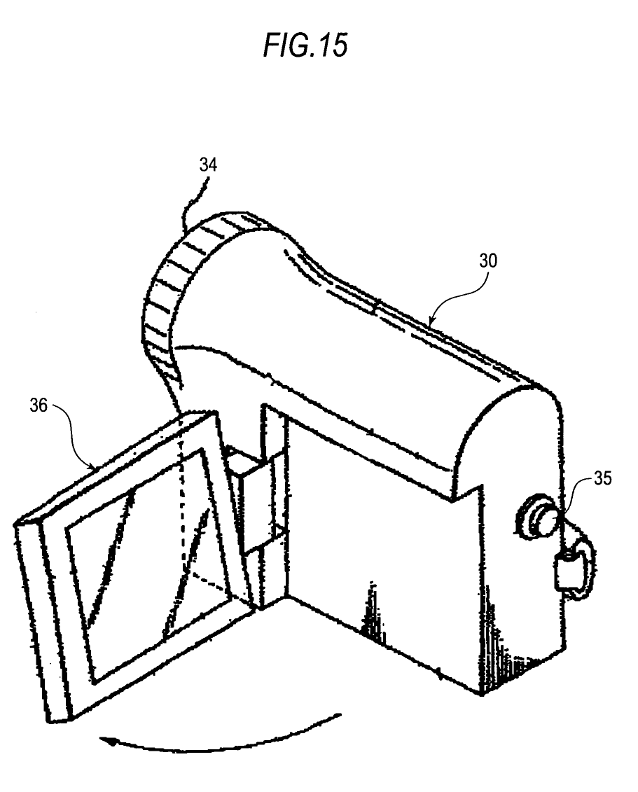

FIG. 15 is an example of a video camera according to the second embodiment of the present invention. This video camera is a video camera to which the first embodiment of the present invention is applied. This video camera includes a main unit 30, a subject photographing lens 34 disposed on a side facing the front side, a photographing start/stop switch 35, a monitor 36, and the like. The video camera is manufactured by using the display device 100 according to the first embodiment of the present invention as the monitor 36 thereof.

In the first embodiment of the present invention, an example in which the luminance gray scales of 10 bits are represented through the number of steps of the signal electric potential of 8 bits has been described. However, an embodiment of the present invention is not limited thereto. For example, representation of the luminance gray scales of 10 bits may be implemented through the number of steps of the signal electric potential of 6 bits. On the other hand, representation of the luminance gray scales of 12 bits may be implemented through the number of steps of the signal electric potential of 10 bits.

The embodiments of the present invention represent examples for implementing the present invention. Thus, as is clarified in the embodiments of the present invention, there is correspondence relationship between each item according to an embodiment of the present invention and an invention specifying item according to an embodiment of the present invention. Similarly, there is correspondence relationship between each invention specifying item according to an embodiment of the present invention and each item having the same name being assigned thereto in the embodiment of the present invention. However, the present invention is not limited to the embodiments, and various changes can be made therein for the implementation thereof in the scope not departing from the concept of the present invention.

The present application contains subject matter related to that disclosed in Japanese Priority Patent Application JP 2009-255646 filed in the Japan Patent Office on Nov. 9, 2009, the entire contents of which is hereby incorporated by reference.

What is claimed is:

1. A display device comprising:
a plurality of pixel circuits;
a signal electric potential generating unit that generates a first signal electric potential, which is used for increasing the number of gray scales of luminance of light emission of the pixel circuits, and a second signal electric potential, which is equal to or higher than the first signal electric potential, based on a video signal; and
a control signal generating unit that generates a control signal used for supplying the first and second signal electric potentials to the pixel circuits,
wherein each of the plurality of the pixel circuits includes
a holding capacitor used for maintaining a signal voltage corresponding to the second signal electric potential,
a writing transistor that writes the second signal electric potential to one end of the holding capacitor based on the control signal after writing the first signal electric potential,
a driving transistor that outputs a signal current based on the signal voltage corresponding to mobility of the driving transistor at the first signal electric potential written by the writing transistor, and
a light emitting device that emits light in accordance with the signal current output from the driving transistor.

2. The display device according to claim 1, wherein the signal electric potential generating unit decreases a step width of the second signal electric potential as the second signal electric potential decreases.

3. The display device according to claim 2,
wherein the signal electric potential generating unit generates an electric potential used for suppressing supply of the current corresponding to the mobility from the driving transistor to the other end of the holding capacitor in a low signal range in which the second signal electric potential is low as the second signal electric potential, and
wherein the driving transistor outputs the signal current based on the signal voltage corresponding to the mobility at the second signal electric potential.

4. The display device according to claim 3, wherein the signal electric potential generating unit generates an electric potential used for suppressing supply of the current corresponding to the mobility from the driving transistor to the other end of the holding capacitor in the low signal range that is about 1/10 of the entire range of the second signal electric potential as the first signal electric potential.

5. The display device according to claim 2, wherein the signal electric potential generating unit generates the first and second signal electric potentials that are the same electric potential in the low signal range in which the second signal electric potential is low.

6. The display device according to claim 1, further comprising:
a selection circuit that selects an electric potential for which a voltage maintained in the holding capacitor is equal to or lower than a voltage corresponding to a threshold voltage of the driving transistor and supplies the selected electric potential to the pixel circuits until the second signal electric potential is generated after the first signal electric potential is generated by the signal electric potential generating unit,
wherein the writing transistor supplies the electric potential selected by the selection circuit to the one end of the holding capacitor.

7. An electronic apparatus comprising:
a plurality of pixel circuits;
a signal electric potential generating unit that generates a first signal electric potential, which is used for increasing the number of gray scales of luminance of light emission of the pixel circuits, and a second signal electric potential, which is equal to or higher than the first signal electric potential, based on a video signal; and
a control signal generating unit that generates a control signal used for supplying the first and second signal electric potentials to the pixel circuits,
wherein each of the plurality of the pixel circuits includes
a holding capacitor used for maintaining a signal voltage corresponding to the second signal electric potential,
a writing transistor that writes the second signal electric potential to one end of the holding capacitor based on the control signal after writing the first signal electric potential,
a driving transistor that outputs a signal current based on the signal voltage corresponding to mobility of the driving transistor at the first signal electric potential written by the writing transistor, and
a light emitting device that emits light in accordance with the signal current output from the driving transistor.

8. A display device comprising:
a plurality of pixel circuits; and
a signal generating unit that generates a first signal and a second signal,
wherein the pixel circuits includes
a capacitive unit that stores a signal voltage including a signal based on the first signal and the second signal, the first signal being written to one end of the capacitive unit prior to the second signal;
a driving transistor that outputs a signal current based on the signal voltage; and
a light emitting device that emits light in accordance with the signal current output from the driving transistor.

9. The display device according to claim 8,
wherein a signal current based on the first signal is input into the other end of the capacitive unit through the driving transistor while the first signal is being written to the one end of said capacitive unit

10. The display device according to claim 9,
wherein a voltage stored in the capacitive unit after the first signal is written is based on both a signal corresponding to mobility of the driving transistor and the first signal.

11. The display device according to claim 8,
wherein the signal voltage stored in the capacitive unit is a value corresponding to the second signal subtracted by a value corresponding to the first signal.
